(19) United States
(12) Patent Application Publication
(10) Pub. No.: US 2010/0038900 A1
(43) Pub. Date: Feb. 18, 2010

(54) SWIVEL CONNECTION FOR A FIREFIGHTING DEVICE

(75) Inventor: James M. Trapp, Galien, MI (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: ELKHART BRASS MANUFACTURING COMPANY, INC., Elkhart, IN (US)

(21) Appl. No.: 12/537,679

(22) Filed: Aug. 7, 2009

Related U.S. Application Data
(60) Provisional application No. 61/088,925, filed on Aug. 14, 2008.

(51) Int. Cl. F16L 27/00

(52) U.S. Cl. 285/275

(57) ABSTRACT

A fluid delivery device has a fluid delivery device body with an inlet, an outlet, and a passageway extending from the inlet to the outlet, with a first annular seal located at the inlet. An annular fluid connection member has a threaded portion adapted to threadably attached to a fluid supply conduit where an annular second seal is optionally located. An intermediate member is located downstream of the fluid connection member and engages the first seal. The intermediate member is rotatably mounted to the fluid delivery device body at the inlet and to the fluid connection member at a location upstream of the inlet. The fluid connection member, intermediate member, and fluid delivery device body are each independently rotatable with respect to one another.

### CROSS-REFERENCE TO RELATED APPLICATION

This application claims priority from U.S. patent application Ser. No. 61/088,925, filed Aug. 14, 2008, entitled SWIVEL CONNECTION FOR A FIREFIGHTING DEVICE, which is incorporated by reference herein in its entirety.

### TECHNICAL FIELD AND BACKGROUND OF THE INVENTION

The present invention relates generally to a swivel connection and, more particularly, to a swivel connection for connecting a fire fighting fluid delivery device, such as a nozzle, to a hose or other fluid supply conduit.

Traditional inlet couplers for fire fighting fluid delivery devices that provide swivel connections fall into two main categories, namely, swivel connections that provide alignment control and are free to swivel (sometimes referred to as “free swivel”) or swivel connections that are fixed when tightened down (typically referred to as “swivel”). Free swivel connections that provide alignment control allow the fluid delivery device to be turned or rotated even when under fluid pressure and are typically sealed by an o-ring seal. To connect a hose to the fluid delivery device, however, a fire fighter must rotate the swivel connection against the frictional forces between the swivel coupling and the o-ring seal. Standard swivel connections, on the other hand, use a gasket to seal the connection between the hose and the fluid delivery device, which is compressed by the hose as the swivel connection is tightened onto the hose. These types of swivel connections allow the fluid delivery device to be attached to the fluid supply conduit without rotating the swivel connection against the friction force of the seal, and are therefore easier for the fire fighter to use. However, when the hose is connected to the fluid delivery device using these standard swivel connections, the fluid delivery device may not be realigned with respect to the hose and instead require the fire fighter to loosen the swivel connection, rotate the fluid delivery device, and then re-tighten the swivel connection to thereby realign the fluid delivery device.

Consequently, these traditional swivel couplers increase the time and effort required to connect a fluid delivery device to a fluid supply conduit and adjust the rotational orientation of the fluid delivery device. Accordingly, there is a need for an inlet coupler that will reduce the time required for attaching a fire fighting fluid delivery device to a fluid supply conduit while maintaining the ability to adjust the alignment of fluid delivery device relative to the supply conduit or hose.

### SUMMARY OF THE INVENTION

Accordingly, the present invention provides a swivel connection that separates or decouples the function of connecting a fluid supply conduit, such as a hose, to a fluid delivery device, such as a nozzle, from the function of aligning the fluid delivery device relative to the fluid supply conduit. The present invention provides a fluid delivery device with a serial swivel connection that decouples the attachment of a hose or other fluid supply conduit to the fluid delivery device and the sealing of the adjustment portion of swivel connection to the fluid delivery device. Because the sealing of the adjustment portion of swivel connection to the fluid delivery device is decoupled from the fluid connection portion of the swivel connection, rotation of the fluid connection portion required for threadably attaching the hose to the fluid delivery device is not hampered by frictional force imposed by any seals, and attaching the hose to the fluid delivery device is thereby made easier and faster. Therefore, the swivel connection of the present invention allows a user to rotate the fluid delivery device even after a hose has been securely connected to the fluid delivery device body.

In a first embodiment, a fluid delivery device includes a fluid delivery device body having an inlet, an outlet, a passageway extending from the inlet to the outlet, and a first annular seal or sealing member at the inlet. An annular fluid connection member has a first inner surface with a threaded portion, and the fluid connection member is adapted to threadably attach to a fluid supply conduit. An annular intermediate member has a second inner surface, and is located downstream of the fluid connection member. The second inner surface of the intermediate annular member engages the first seal. The intermediate member is rotatably mounted to the fluid delivery device body at the inlet and the intermediate member is rotatably mounted to the fluid connection member at a location upstream of the inlet. The fluid connection member, the intermediate member, and the fluid delivery device body are each independently rotatable with respect to one another.

In one form, the fluid delivery device further includes a second annular seal or sealing member located between the threaded portion of the fluid connection member and the intermediate member. The second annular seal or sealing member seals the fluid supply conduit to the fluid delivery device.

In a second form, a fluid delivery device includes a fluid delivery device body having an inlet, an outlet, a passageway extending from the inlet to the outlet, and a first annular seal at the inlet. A fluid connection member has a first annular surface with a threaded portion, and the fluid connection member is adapted to threadably attach to a fluid supply conduit.

An annular intermediate member has a second annular surface, and is located between the fluid delivery device body and the fluid connection member. The second annular surface of the intermediate member engages the first seal. A second annular seal is located between the threaded portion of the fluid connection member and the intermediate member, and the first seal and the second seal are operable to seal the fluid delivery device when the outlet is sealed and to direct fluid through the passageway when the outlet is open. The fluid connection member, the intermediate member, and the fluid delivery device body are each independently rotatable with respect to one another.

In an aspect of either the first or second forms of the invention, the fluid delivery device body may include a downstream external annular groove at the inlet and the intermediate member may include a downstream internal annular groove adjacent to the second annular surface. The downstream internal groove and the downstream external groove cooperate to define a downstream bearing race that receives ball bearings. The internal groove may be located downstream of the second annular surface and the second seal.

In another aspect of either the first or second forms of the invention, the inlet and the intermediate member may define downstream bearing surfaces with low friction coatings for low friction contact. For example, the downstream bearing surfaces may be coated with a Teflon®-impregnated hardcoat.

In another aspect of either the first or second forms of the invention, the intermediate member may include a recessed annular surface, with the fluid connection member rotatably mounting to the intermediate member at the recessed annular surface. The recessed annular surface may further include an upstream external annular groove, and the first annular surface may include an upstream internal annular groove that is located downstream of the threaded portion. The upstream internal groove and the upstream external groove cooperate to define an upstream bearing race that is adapted to receive ball bearings.

In another aspect of either the first or second forms of the invention, the recessed annular surface and the first annular surface may each define upstream bearing surfaces with low friction coatings for low friction contact. For example, the upstream bearing surfaces are coated with a Teflon®-impregnated hardcoat In yet another aspect of either the first or second forms of the invention, the fluid connection member and/or the intermediate member may include a first outer annular surface with grip enhancing features such as knurling, protrusions extending outwardly from the outer annular surface, ridges or the like.

Still another aspect of either the first or second forms of the invention may include a threaded aperture in the fluid connection member, with the first annular surface comprising a first inner annular surface, and the threaded aperture extending between the first outer annular surface and a first inner annular surface. A similar threaded aperture in the intermediate member may also extend between the second outer annular surface and the second inner annular surface, with the second annular surface comprising the second inner annular surface.

In yet another aspect of either the first or second forms of the invention, the force required for rotating the intermediate member may be greater than the force required for rotating the fluid connection member.

In yet another aspect of either the first or second forms of the invention, the fluid delivery device body may be a solid stream nozzle. In addition, the fluid delivery device body may include a pistol grip handle.

In another aspect, a method of attaching a fluid supply conduit to a fluid delivery device includes rotatably connecting a fluid connection member to an annular intermediate member at a first annular surface of the fluid connection member, and rotatably connecting the intermediate member to a fluid delivery device body at an inlet portion of the fluid delivery device body, such that a second annular surface of the intermediate member is engaged with a first seal. The fluid connection member is then rotated to threadably connect a fluid supply conduit to a threaded portion of the fluid connection member, and the fluid delivery device body is rotated to a desired orientation without rotating the fluid connection member.

In one aspect, the method may include placing a second annular seal or sealing member between the threaded portion of the fluid connection member and the intermediate member to thereby seal the fluid supply conduit to the fluid delivery device.

In another aspect, the method may include rotatably connecting the fluid connection member to the intermediate member and engaging the first annular surface of the fluid connection member with a recessed annular surface of the intermediate member.

These and other objects, advantages, purposes and features of the present invention will become apparent upon review of the following specification in conjunction with the drawings.

### BRIEF DESCRIPTION OF THE DRAWINGS

FIG. 1 is a perspective view of a fire fighting fluid delivery device in the form of a nozzle assembly with a serial swivel connection in accordance with the present invention;

FIG. 2 is a side elevation of the nozzle assembly shown in FIG. 1;

FIG. 3A is a side section of the nozzle assembly shown in FIG. 2;

FIG. 3B is an enlarged detailed view of area IIIB of FIG. 3A;

FIG. 4A is an end elevation of an intermediate annular member in accordance with the present invention;

FIG. 4B is a side section of the intermediate annular member taken along lines IVB-IVB of FIG. 4A;

FIG. 5A is an end elevation of a fluid connection member in accordance with the present invention; and

FIG. 5B is a side section of the fluid connection member taken along line VB-VB of FIG. 5A.

### DESCRIPTION OF THE PREFERRED EMBODIMENTS

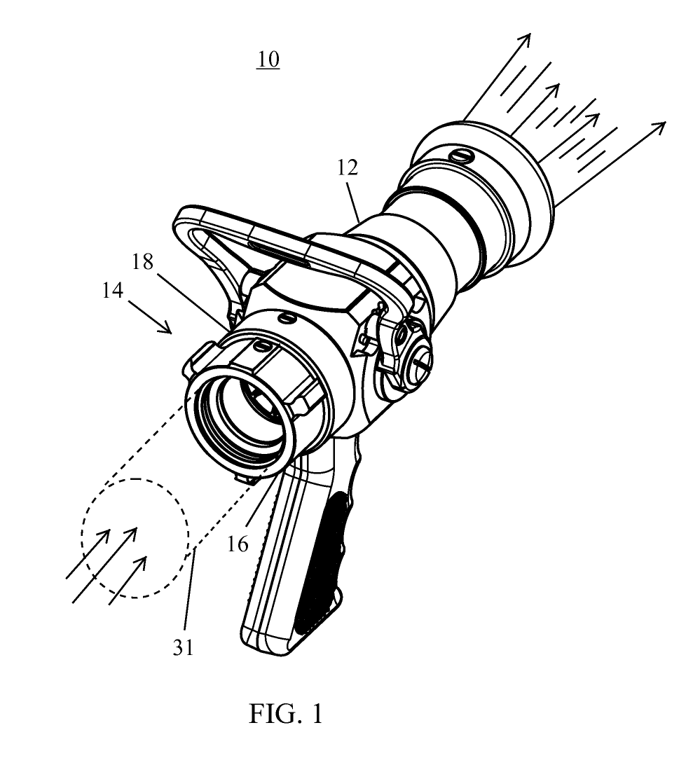

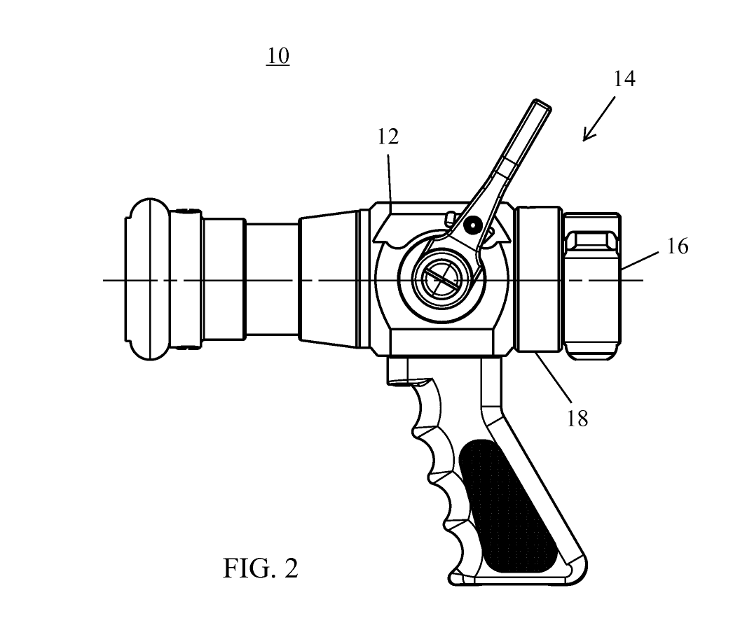

Referring now to FIG. 1, the numeral 10 generally designates a nozzle assembly with a serial swivel connection in accordance with the present invention. As will be more fully described below, nozzle assembly 10 provides a mechanism that allows for rotation of the swivel connection components and of the nozzle body independently with respect to one another, thereby facilitating the fast and efficient attachment and operation of a fire fighting nozzle to a fluid supply conduit or hose, as well as easier adjustment of the position of the nozzle body after connection to the fluid supply conduit and hose. Although described in reference to a nozzle assembly, it should be understood that the present invention may be used to provide connections for other fire fighting fluid delivery devices, such as monitors, wyes, pumps, valves, or the like.

Nozzle assembly 10 includes a nozzle body 12 and a serial swivel connection 14 that decouples the connection of the nozzle body to a fluid supply conduit, such as a hose, and the alignment of the nozzle assembly relative to the hose. Connection 14 includes a fluid connection member 16 and an intermediate member 18 located between the fluid connection member and the nozzle body. In the illustrated embodiment, swivel connection 14 is mounted to a solid stream nozzle assembly such as the nozzle assembly disclosed in U.S. provisional patent application Ser. No. 61/029,066 (attorney docket ELK01 P-334), which is hereby incorporated herein by reference in its entirety. However, it will be apparent to one of ordinary skill in the art that swivel connection 14 may be mounted to any suitable fire fighting fluid delivery device without departing from the spirit and scope of the present invention. For example, other suitable fire fighting delivery devices include monitors, including high pressure monitors, such as disclosed in copending United States Patent applications entitled FIRE-FIGHTING MONITOR, Ser. No. 10/962,271, filed Oct. 8, 2004 (Attorney Docket ELK01 P-307A) and HIGH PRESSURE MONITOR, Ser. No. 11/519,627, filing date Sep. 11, 2006 (Attorney Docket ELK01 P-317A (utility of P-317); wyes; pumps; valves; and other fire fighting nozzles, such as disclosed in U.S. patent applications entitled ADJUSTABLE SMOOTH BORE NOZZLE, Ser. No. 11/036,621, filed on Jan. 14, 2005 (Attorney Docket No. ELK01 P-313), LEVER CONTROLLED COMBINATION ADJUSTABLE SOLID STREAM NOZZLE ASSEMBLY AND HOSE SHUTOFF VALVE, Ser. No. 61/087,310, filing date Aug. 8, 2008 (Attorney Docket ELK01 P-334A), all of which are commonly owned by Elkhart Brass Manufacturing of Elkhart Company, Inc., of Elkhart, Ind., and are incorporated by reference in their entireties herein.

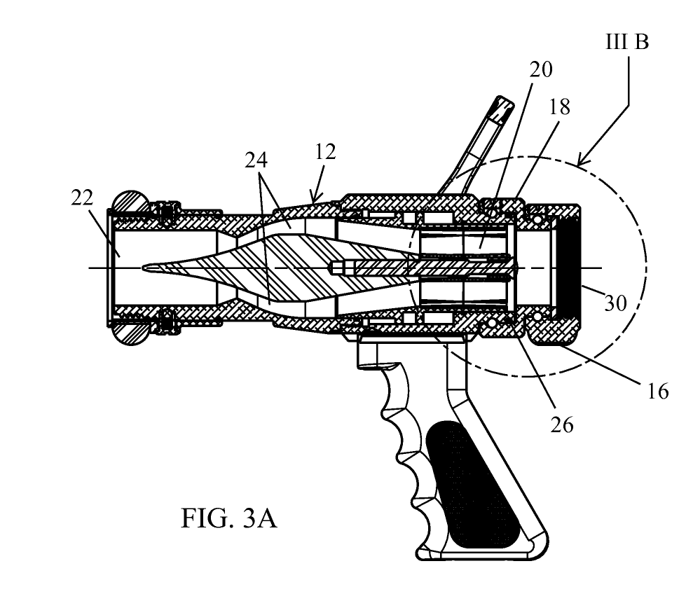

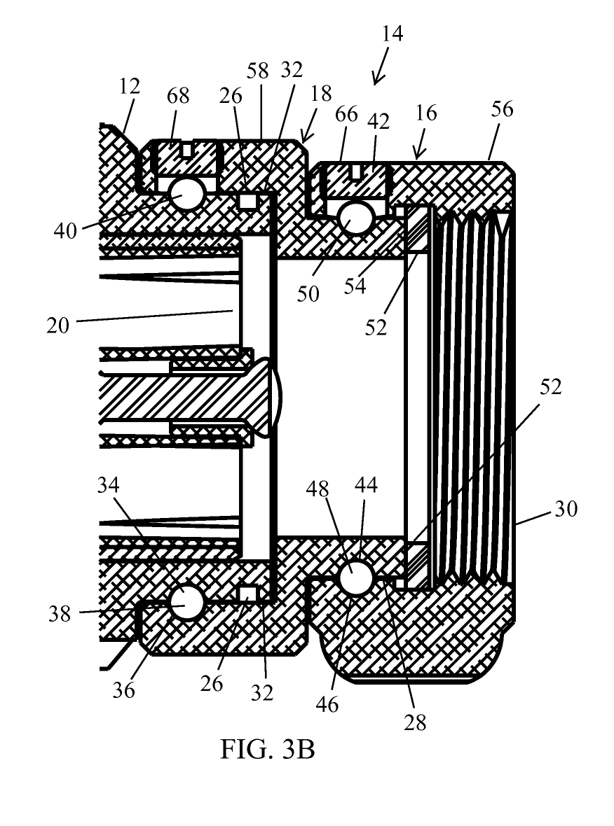

As best seen in FIGS. 3A and 3B, nozzle body 12 includes an inlet 20, an outlet 22, a passageway 24 extending from inlet 20 to outlet 22, and a first annular seal or sealing member or gasket 26, such as an o-ring seal, located at inlet 20. Fluid connection member 16 is generally annular in shape and has a first annular portion with an inner annular surface or inner diameter 28 and a second annular portion with a threaded portion 30 that is adapted to threadably attach to a fluid supply conduit, such as a hose or fire hose 31 (FIG. 1). Fluid connection member 16 is rotatably mounted to intermediate member 18, as discussed in detail below.

Intermediate member 18 is generally annular in shape and has first annular portion with an inner annular surface or inner diameter 32 for connection to nozzle body 12 at inlet 20. Intermediate member 18 is rotatably mounted to nozzle body 12 at inlet 20, so that inner annular surface 32 compresses and seals against first seal 26, thereby sealing in any fluid passing through passageway 24 at inlet 20. Thus, intermediate member 18 is attached to nozzle body 12 at inlet 20, while fluid connection member 16 is attached to intermediate member 18 at a location upstream of inlet 20. Further, fluid connection member 16, intermediate member 18, and nozzle body 12 are all independently rotatable with respect to one another.

Low friction connections are provided between fluid connection member 16, intermediate member 18, and nozzle body 12 to facilitate rotation of each with respect to the others. For example, bearing races and bearings may be provided between adjacent rotational components to facilitate rotation. Upstream and downstream bearing races may be provided for each of the two rotational junctures (i.e., between the two parts or members of the swivel connection and between the swivel connection and the nozzle body). In the illustrated embodiment as best seen in FIGS. 3A-5B, nozzle body 12 includes an external annular groove 34 that is located at inlet 20 and downstream of fluid connection member 16. to second inner annular surface 32 and, accordingly, is also downstream of fluid connection member 16. When intermediate member 18 is mounted to nozzle body 12, annular grooves 34, 36 cooperate to define a downstream bearing race 38 adapted to receive a plurality of bearings of ball bearings 40 (FIG. 3B). Downstream bearing race 38 and bearings 40 are ideally located in second inner annular surface 32 downstream of first seal 26, which places bearings 40 on the dry side of first seal 26 to ensure that bearings 40 remain dry during operation of nozzle assembly 10. Optionally, second inner annular surface 32 and the adjacent portion of nozzle body 12 may be coated with a low friction coating, such as Teflon®-impregnated hardcoat or the like, to define bearing surfaces with low friction contact to further ease rotation of intermediate member 18 and nozzle body 12 with respect to one another.

Optionally, fluid connection member 16 may be rotatably mounted to intermediate member 18 on a second annular portion that has a smaller outside and inside diameter than first annular portion of intermediate member, which forms a recessed annular surface 42 of the intermediate member. Recessed annular surface 42 includes an external annular groove 44 that is located upstream of inlet 20 and downstream of threaded portion 30. Fluid connection member 16 includes a corresponding internal annular groove that is also upstream of inlet 20 and downstream of threaded portion 30, so that when fluid connection member is mounted to intermediate member, annular grooves 44, 46 cooperate to define an upstream bearing race 48 for receiving a plurality of bearings or ball bearings 50. Similar to bearings 40 (discussed above), bearings 50 facilitate smooth rotation of fluid connection member 16 with respect to intermediate member 18 and/or nozzle body 12. Further, recessed annular surface 42 and the adjacent portion of first inner annular surface 28 may be coated with a low friction coating, such as Teflon®-impregnated hardcoat or the like, to define low friction bearing surfaces between fluid connection member 16 and intermediate member 18. Moreover, such low friction coating may be applied to nozzle body 12, fluid connection member 16 and intermediate member 18 in their entireties, or to any portion thereof to promote low friction operation of nozzle assembly 10 and durability of the respective components or members.

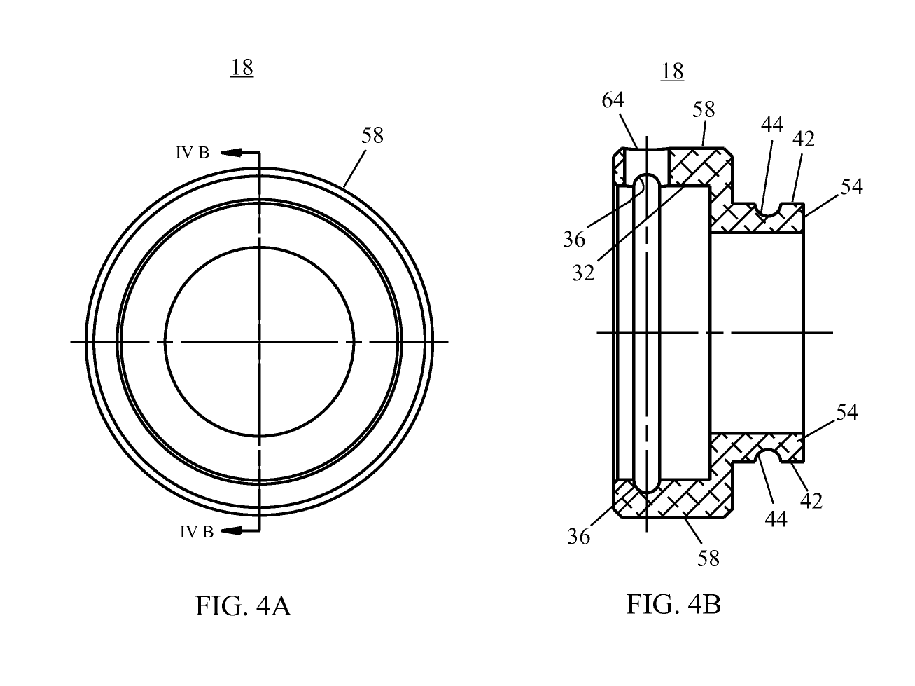

Optionally, a second annular seal or sealing member or gasket 52, such as a flat washer made from rubber and/or silicone, may be placed between threaded portion 30 and intermediate member 18, such as between threaded portion 30 and an upstream face 54 of the second annular portion of the intermediate member (FIG. 4B). When so positioned, second seal 52 prevents fluid from leaking between fluid connection member 16 and intermediate member 18, and also protects bearings 50 and upstream bearing race 48 from moisture, similar to the sealing protection provided by first seal 26 with respect to the downstream bearing race and bearings as set forth above. Moreover, first seal 26 and second seal 52 cooperate to seal nozzle assembly 10 and thereby prevent the fluid flowing in the fluid supply conduit from leaking out of nozzle assembly 10 at inlet 20, and to ensure that fluid is directed substantially exclusively through passageway 24 toward outlet 20 when nozzle assembly 10 is open at outlet 22.

Optionally, the outer annular surface or outer diameter 56 of fluid connection member 16 may have grip enhancing features such as knurling, protrusions, ridges or the like. Such grip enhancing features are desirable to assist in rotation of the fluid connection member, such as by fire fighters operating in cold or wet environments and/or with gloved hands.

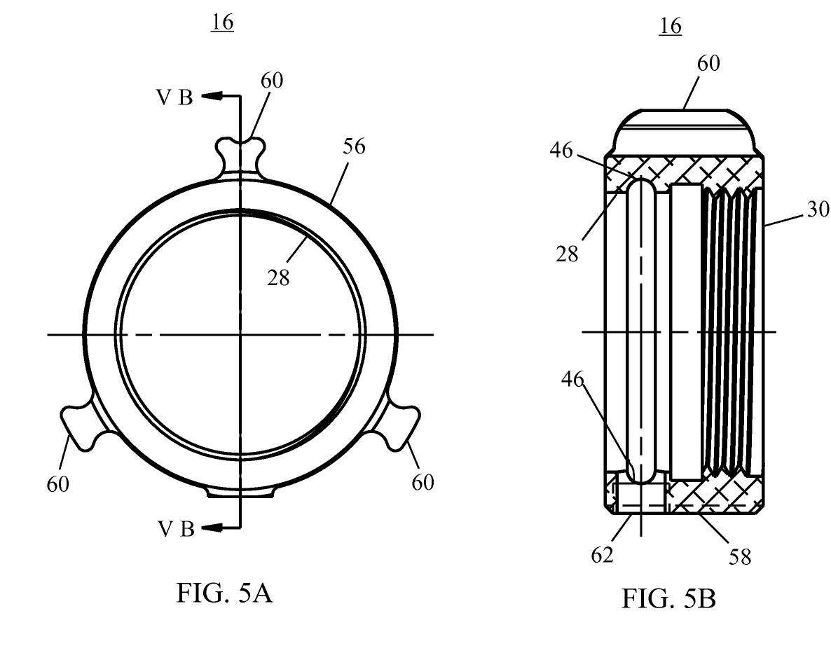

Similarly, the outer annular surface or outer diameter 58 of intermediate member 18 may also include such grip enhancing features. In the illustrated embodiment as best seen in FIGS. 4B and 5B, intermediate member 18 is knurled at second outer annular surface 58, while fluid connection member 16 may include a plurality of radial protrusions or protuberances 60 extending outwardly from first outer annular surface 56 (FIG. 5A).

In the illustrated embodiment, the outer diameter of intermediate member 18 is larger than the outer diameter of fluid connection member 16, excluding protrusions 60 (FIG. 3B).

This arrangement of grip enhancing features and relative diameters facilitates easy rotation of the intermediate member against the frictional forces posed by first seal 26 (as discussed above) by allowing a user to firmly and positively grasp intermediate member 18 without substantial interference by fluid connection member 16. On the other hand, because fluid connection member 16 is easier to rotate than intermediate member 18 (since there is no constant frictional force posed by a seal), protrusions 60 are sufficient for rotation of fluid connection member 16 and for seating and compressing second seal 52 when attaching a hose or fluid supply conduit. For example, for optimal grip and handling, the outer diameter of the fluid connection member may be approximately 2 7/16 inches with the protrusions extending out to a diameter of approximately 3 1/16 inches, while the outer diameter of the intermediate member may be approximately 2¾ inches. However, it will be apparent to one skilled in the art that any combination of grip enhancing features and sizes may be employed without departing from the spirit and scope of the present invention.

Optionally, to facilitate insertion of the respective bearings, the fluid connection member and/or the intermediate member may include a threaded aperture or hole 62, 64 (FIGS. 4B and 5B), respectively, for receiving set screws 66, 68 respectively (FIG. 3B). In (FIGS. 4B and 5B), respectively, for receiving set screws 66, 68 respectively (FIG. 3B). In the illustrated embodiment, apertures 62, 64 are positioned on the fluid connection member and the intermediate member, respectively, to correspond and align radially with the upstream internal annular groove 46 and the downstream external annular groove 34, respectively so that the bearings can be easily inserted through the openings, which are then plugged by the set screws 66, 68.

In general, the force required to rotate the fluid connection member will be less than the force required to rotate the intermediate member. This is because the friction between the first seal and the second inner annular surface (for sealing the swivel connection to the nozzle body) must be overcome to rotate the intermediate member, while rotation of the fluid connection member will only experience a frictional force related to the second seal (for sealing a hose to the swivel connection) when a fluid supply conduit is threadably attached at the threaded portion sufficiently far to impact or compress the second seal but prior to releasing water pressure into the fluid conduit. Therefore, the serial swivel connection of the present invention separates or decouples the sealing of the swivel connection to the inlet of the nozzle body from the threaded attachment of a fluid supply conduit to the swivel connection. Thus, a fire fighter using the serial swivel connection may quickly and easily thread a nozzle assembly to a hose using the fluid connection member, and may tighten the fluid connection member sufficiently to seal the nozzle assembly to the hose. The fire fighter may then adjust the rotational orientation of the nozzle body (operating only against the force of the first seal), even if water pressure is present during the use of the nozzle assembly, without loosening or altering the seal between the hose and the fluid connection member (created by the second seal). The intermediate member may also be rotated independently of the fluid connection member and/or the nozzle body. With the hose securely attached and the nozzle body properly oriented, the nozzle assembly may then be used in a traditional manner by a fire fighter.

Changes and modifications to the specifically described embodiments may be carried out without departing from the principles of the present invention, which is intended to be limited only by the scope of the appended claims, as interpreted according to the principles of patent law including the doctrine of equivalents.

1. A fluid delivery device comprising:
a fluid delivery device body having an inlet, an outlet, a passageway extending from said inlet to said outlet, and an annular first seal at said inlet;
an annular fluid connection member having a first annular surface with a threaded portion, wherein said fluid connection member is adapted to threadably attach to a fluid supply conduit;
an annular intermediate member having a second annular surface, said intermediate member being located downstream of said fluid connection member, wherein said second annular surface of said intermediate member seals against said first seal;
wherein said intermediate member is rotatably mounted to said fluid delivery device body at said inlet and said intermediate member is rotatably mounted to said fluid connection member at a location upstream of said inlet; and
wherein said fluid connection member, said intermediate member, and said fluid delivery device body are each independently rotatable with respect to one another.

2. The fluid delivery device as claimed in claim 1, further comprising a second annular seal located between said threaded portion of said fluid connection member and said intermediate member, wherein said second annular seal seals the fluid supply conduit to the fluid delivery device.

3. The fluid delivery device as claimed in claim 1 wherein said fluid delivery device body comprises an annular downstream external groove at said inlet and said intermediate member comprises an annular downstream internal groove adjacent to said second annular surface, wherein said downstream internal groove and said downstream external groove cooperate to define a downstream bearing race, and a plurality of ball bearings received in said downstream bearing race.

4. The fluid delivery device as claimed in claim 3 wherein said internal groove is located downstream of said second annular surface and said second seal.

5. The fluid delivery device as claimed in claim 1 wherein at least one of said fluid connection member and said intermediate member comprises an outer annular surface with grip enhancing features comprising at least one chosen from knurling, protrusions extending outwardly from said outer annular surface, and ridges.

6. The fluid delivery device as claimed in claim 1 wherein the force required for rotating said intermediate member is greater than the force required for rotating said fluid connection member.

7. The fluid delivery device as claimed in claim 1 wherein said fluid delivery device body comprises a solid stream fluid delivery device.

8. A fluid delivery device comprising:
a fluid delivery device body having an inlet, an outlet, a passageway extending from said inlet to said outlet, and a first annular seal at said inlet;
a fluid connection member having a first annular surface with a threaded portion, wherein said fluid connection member is adapted to threadably attach to a fluid supply conduit;
an annular intermediate member having a second annular surface, said intermediate member being located between said fluid delivery device body and said fluid connection member, wherein said second annular surface of said intermediate member seals against said first seal;
an annular second seal located between said threaded portion of said fluid connection member and said intermediate member;
wherein said intermediate member is rotatably mounted to said fluid delivery device body at said inlet and said intermediate member is rotatably mounted to said fluid connection member at a location upstream of said inlet;
wherein said first seal and said second seal are operable to seal the fluid delivery device when said outlet is sealed and to direct fluid through said passageway when said outlet is open; and
wherein said fluid connection member, said intermediate member, and said fluid delivery device body are each independently rotatable with respect to one another.

9. The fluid delivery device as claimed in claim 8 wherein said fluid delivery device body comprises an annular downstream external groove at said inlet and said intermediate member comprises an annular downstream internal groove adjacent to said second annular surface, wherein said downstream internal groove and said downstream external groove cooperate to define a downstream bearing race, and a plurality of ball bearings received in said downstream bearing race.

10. The fluid delivery device as claimed in claim 9 wherein said internal groove is located downstream of said second annular surface and said second seal.

11. The fluid delivery device as claimed in claim 8 wherein said inlet and said intermediate member define downstream bearing surfaces with low friction contact.

12. The fluid delivery device as claimed in claim 11 wherein said downstream bearing surfaces are coated with a Teflon®-impregnated hardcoat.

13. The fluid delivery device as claimed in claim 8, said intermediate member further comprising a recessed annular surface wherein said fluid connection member rotatably mounts to said intermediate member at said recessed annular surface.

14. The fluid delivery device as claimed in claim 13, said recessed annular surface including an annular upstream external groove and said first annular surface including an annular upstream internal groove that is located downstream of said threaded portion, wherein said upstream internal groove and said upstream external groove cooperate to define an upstream bearing race, and a plurality of ball bearings received in said upstream bearing race.

15. The fluid delivery device as claimed in claim 13 wherein said recessed annular surface and said first annular surface each define upstream bearing surfaces with low friction contact.

16. A method of attaching a fluid supply conduit to an inlet of a fluid delivery device comprising:
rotatably mounting an intermediate member to the fluid delivery device body at the inlet of the fluid delivery device;
said rotatably mounting sealing the intermediate member at the delivery device body;
rotatably mounting a fluid connection member to the intermediate member;
threading a threaded portion of the fluid connection member on to the fluid supply conduit; and
said threading sealing the fluid supply conduit to the fluid connection member and the intermediate member.

17. The method of claim 16, further comprising dimensioning a portion of the fluid connection member so that it projects outwardly beyond the intermediate member.
